(19) United States
(12) Patent Application Publication
(10) Pub. No.: US 2020/0068861 A1
(43) Pub. Date: Mar. 5, 2020

(54) Fishing Lure

(71) Applicant: Gary Justice, Zanesville, OH (US)

(72) Inventor: Gary Justice, Zanesville, OH (US)

(21) Appl. No.: 16/559,722

(22) Filed: Sep. 4, 2019

Related U.S. Application Data
(60) Provisional application No. 62/727,101, filed on Sep. 5, 2018.

(51) Int. Cl. A01K 85/01; A01K 85/08; A01K 93/00

(52) U.S. Cl. CPC A01K 85/01; A01K 93/00; A01K 85/08

(57) ABSTRACT

A fishing lure. The fishing lure includes a flexible body having a first end opposite a second end. A support frame extends through the flexible body between the first end and the second end. The support frame includes a nylon mesh in a spiral configuration to provide additional structural support to the flexible body. The fishing lure is designed to mimic the natural movement of typical bait creatures.

### CROSS REFERENCE TO RELATED APPLICATIONS

This application claims the benefit of U.S. Provisional Application No. 62/727,101 filed on Sep. 5, 2018. The above identified patent application is herein incorporated by reference in its entirety to provide continuity of disclosure.

### BACKGROUND OF THE INVENTION

The present invention relates to fishing lures. More particularly, the present invention pertains to fishing lures having a support frame extending therethrough to provide structural integrity without impeding flexibility.

Many people enjoy fishing regularly, however using traditional baits and lures may be ineffective at drawing fish to the line. Additionally, these lures typically require replacement after one or more uses, which may become expensive. Furthermore, when fishing at night, it can often be difficult to ascertain where the line was cast or whether a fish has been attracted to the lure. Therefore, a device that maximizes the durability of the fishing lure while also providing additional visibility and catching effectiveness is desired.

In light of the devices disclosed in the known art, it is submitted that the present invention substantially diverges in design elements from the known art and consequently it is clear that there is a need in the art for an improvement to existing fishing lures. In this regard, the instant invention substantially fulfills these needs.

### SUMMARY OF THE INVENTION

In view of the foregoing disadvantages inherent in the known types of fishing lures now present in the known art, the present invention provides a fishing lure wherein the same can be utilized for providing convenience to the user when fishing regularly without necessarily requiring replacement thereof.

The fishing lure comprises a flexible body having a first end opposite a second end. A support frame extends through the flexible body between the first end and the second end, wherein the support frame comprises a nylon mesh in a spiral configuration. In some embodiments, the flexible body further includes a light source therein. In other embodiments, a plurality of ribs are disposed along a length of the flexible body. In another embodiment, a width of the plurality of ribs decreases from the first end towards the second end. In yet another embodiment, a tail is affixed to the second end, wherein the tail comprises a planar member. In some embodiments, the tail further comprises a cutout therethrough, wherein the cutout defines a pair of tail segments. In another embodiment, the flexible body further comprises reflective flakes embedded therein. In other embodiments, the flexible body further comprises a scent additive therein, the scent additive configured to attract fish. In yet another embodiment, the flexible body further comprises a floatation additive configured to enable the flexible body to float within a body of water. In some embodiments, the light source comprises a chemiluminescent glow stick. In another embodiment, the support frame further comprises a plurality of knots thereon. In other embodiments, the plurality of knots are disposed at regular intervals along a length of the support frame.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the fishing lure.

FIG. 2 shows a perspective view of the support frame of an embodiment of the fishing lure.

FIG. 3 shows a perspective view of an alternate embodiment of the fishing lure.

FIG. 4A shows a close-up view of the tail of an embodiment of the fishing lure.

FIG. 4B shows a close-up view of the tail of an alternate embodiment of the fishing lure.

### DETAILED DESCRIPTION OF THE INVENTION

Reference is made herein to the attached drawings. Like reference numerals are used throughout the drawings to depict like or similar elements of the fishing lure. The figures are intended for representative purposes only and should not be considered to be limiting in any respect.

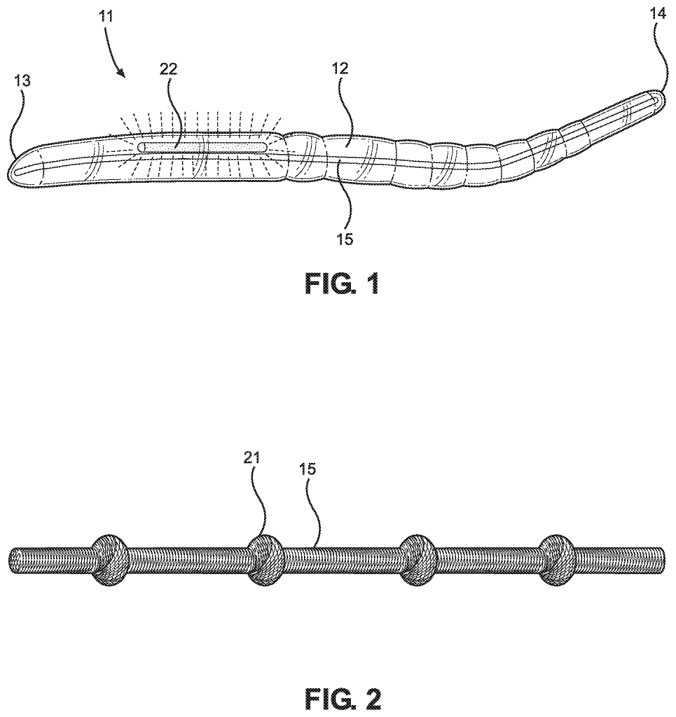

Referring now to FIG. 1, there is shown a perspective view of an embodiment of the fishing lure. The fishing lure 11 comprises a flexible body 12 having a first end 13 opposite a second end 14. In the illustrated embodiment, the flexible body 12 comprises a generally worm-like shape, however, in alternate embodiments, other shapes mimicking various animals typically used as fishing lures or bait are contemplated. A support frame 15 extends through the flexible body 12 from the first end 13 to the second end 14, wherein the support frame 15 provides additional structural integrity to the fishing lure 11. In this way, the durability of the fishing lure 11 is sufficiently increased, such that a user can utilize the fishing lure 11 multiple times. This allows the user to purchase fewer fishing lures 11 than may otherwise be required for fishing. In alternate embodiments, the flexible body 12 mimics a bait creature having at least one leg. In such embodiments, the support frame 15 branches from the central frame into each leg of the fishing lure 11. In this way, the legs or other protrusions have similar durability to the flexible body 12, ensuring that each leg is retained on the fishing lure 11.

The flexible body 12 can comprise a variety of durable materials, including, but not necessarily limited to rubber, rubberized plastics, or other plastoids. In this way, the durability of the fishing lure 11 can be ensured, while ensuring the fishing lure 11 maintains flexibility along the length of the flexible body 12, such that the fishing lure 11 can more accurately mimic the movement of a worm or other bait creature. In some embodiments, the flexible body 12 further comprises a floatation additive therein, such that the buoyancy of the flexible body 12 is increased, allowing the fishing lure 11 to float on a surface of a body of water. This allows the fishing lure 11 to cast a moving shadow into the body of water, further attracting fish to the fishing lure 11. Generally, the floatation additive comprises an additional material suspended within or in solution with the durable material of the flexible body 12, so as to reduce the density of the flexible body 12. In this way, the flexible body remains buoyant on the body of water. Additionally, in some embodiments, a scent additive can be added to the flexible body 12, such that fish can be attracted to the fishing lure 11 via alluring scents or pheromones. Generally, the material of the flexible body 12 is molded about the support frame 15, such that when the material cures, the support frame 15 is entirely encased within the flexible body 12.

In an exemplary manufacturing method, the support frame 15 is positioned centrally within a mold, wherein the mold comprises the desired bait creature shape for the fishing lure 11. A reactive solution comprising the durable material of the flexible body 12 is introduced to the mold, such that the support frame 15 is surrounded and permeated thereby. Upon curing, the flexible body 12 is removed from the mold, resulting in a durable fishing lure 11 having a desired bait creature shape. Curing can be achieved via a variety of methods reliant on the particular composition of the durable material chosen, including, but not necessarily limited to, allowing an amount of time to pass to allow the solution to solidify via chemical reaction, heating the mold, cooling the mold, or the like. In some embodiments, the solution comprises a combination of the durable material described elsewhere herein and a floatation additive to reduce the density of the flexible body 12 to a desired amount. In alternate embodiments, a scent additive is further included within the solution.

In the illustrated embodiment, the fishing lure 11 further comprises a light source 22 therein. In the shown embodiment, the flexible body 12 comprises a fully or partially transparent material, such that light generated by the light source 22 is transmitted through the flexible body 12 unimpeded, however, in alternate embodiments, the flexible body 12 can comprise a variety of colors or opacities to achieve a desired glow effect. In some embodiments, the light source 22 is permanently affixed within the flexible body 12, however, in some embodiments, the light source 22 is disposed within a compartment within the flexible body 12. In such embodiments, the light source 22 can be removably secured within the flexible body 12, such that a user can easily replace the light source 22 when necessary. In some embodiments, the light source 22 comprises a Light Emitting Diode (LED) light having a rechargeable battery, however, in alternate embodiments, the light source 22 can comprise a chemiluminescent glow stick. In such embodiments, the user can prolong the life of the light source 22 by refrigerating or freezing the fishing lure 11.

Referring now to FIG. 2, there is shown a perspective view of the support frame of an embodiment of the fishing lure. In the illustrated embodiment, the support frame 15 comprises a mesh twisted upon itself to create a spiraled cord configuration. In this way, the durability of the mesh is further increased, while providing a superior bond with the flexible body. As the mesh material includes a plurality of openings therethrough, the material of the flexible body can permeate and surround the entirety of the support frame 15 before the material cures. In some embodiment, the mesh comprises a nylon material, so as to provide increased durability. In the illustrated embodiment, the support frame 15 further comprises a plurality of knots 21 thereon, wherein the plurality of knots 21 increases the surface area of the support frame 15 in contact with the flexible body, thereby further increasing durability thereof and adhesion therewith. In some embodiments, the plurality of knots 21 are regularly distributed along a length of the support frame 15 to evenly distribute forces exerted upon the flexible body during use along an entirety of the flexible body.

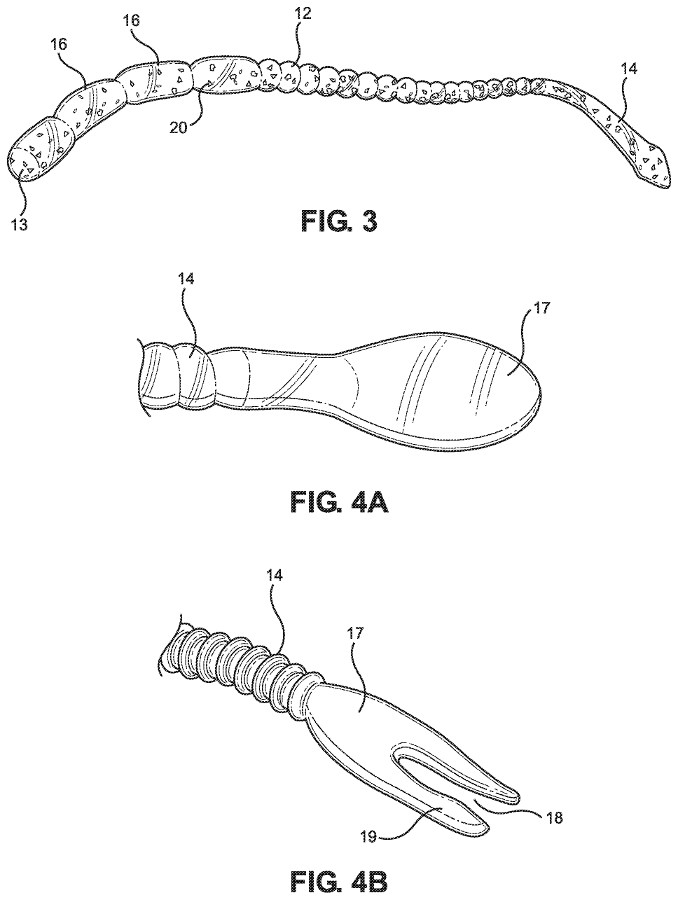

Referring now to FIG. 3, there is shown a perspective view of an alternate embodiment of the fishing lure. In the illustrated embodiment, the flexible body 12 further comprises a plurality of ribs 16 therealong, wherein the plurality of ribs 16 provide a dual purpose. First, the plurality of ribs 16 allow the flexible body 12 to more readily flex along natural pivot points occurring between each rib of the plurality of ribs 16. Secondly, the plurality of ribs 16 further allow the flexible body 12 to more accurately mimic a typical bait creature, such as a worm, nightcrawler, or the like. Furthermore, in the illustrated embodiment, a width of each rib of the plurality of ribs 16 decreases in size from the first end 13 towards the second end 14. In this way, the flexible body 12 more readily mimics the traditional movement of the represented bait creature, as the natural pivot points along the flexible body 12 match those along the bait creature.

In the illustrated embodiment, the flexible body further comprises reflective flakes 20 disposed therein. The reflective flakes 20 are configured to reflect light that penetrates the flexible body 12 as the fishing lure moves below the surface of the water, such that light reflected by the reflective flakes 20 further attracts fish. In the shown embodiment, the reflective flakes 20 are evenly disposed through the flexible body 12 to ensure that light can be reflected from any position along the flexible body 12. In some embodiments, the reflective flakes 20 can include a variety of colored coatings thereon, such that the color of the light reflected therefrom changes based on which reflective flake 20 is contacted by the light.

Referring now to FIGS. 4A and 4B, there are shown close-up views of the tail of alternate embodiments of the fishing lure. In the illustrated embodiments, a tail 17 is affixed to the second end 14 of the flexible body, wherein the tail 17 serves to further mimic a creature's natural movements in a body of water. In the embodiment of FIG. 4A, the tail 17 comprises a generally planar surface similar to a fin. In some embodiments, the tail 17 also tapers outward from the second end 14 towards a central portion of the tail 17, and then tapers inwards from the central portion towards a distal end of the tail 17. In the illustrated embodiment of FIG. 4B, the tail 17 further comprises a cutout 18 disposed through the tail 17, thereby dividing the tail 17 into a pair of tail segments 19. In the illustrated embodiment, the pair of tail segments 19 come to a point at a distal end thereof, such that the tail 17 mimics the shape of a forktail. Each embodiment allows the fishing lure to move in a way similar to the bait creature the fishing lure is meant to mimic, thereby being more enticing to fish than other artificial lures.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A fishing lure, comprising:
a flexible body having a first end opposite a second end;
a support frame extending through the flexible body between the first end and the second end;
wherein the support frame comprises a mesh in a spiral configuration, defining a cord.

2. The fishing lure of claim 1, further comprising a plurality of ribs along a length of the flexible body.

3. The fishing lure of claim 2, wherein a width of the plurality of ribs decreases from the first end towards the second end.

4. The fishing lure of claim 1, further comprising a tail affixed to the second end, wherein the tail comprises a planar member.

5. The fishing lure of claim 4, wherein the tail further comprises a cutout therethrough, the cutout defining a pair of tail segments.

6. The fishing lure of claim 1, wherein the flexible body further comprises reflective flakes embedded therein.

7. The fishing lure of claim 1, wherein the flexible body comprises a scent additive therein, wherein the scent additive is configured to attract fish.

8. The fishing lure of claim 1, wherein the flexible body further comprises a floatation additive therein, such that the flexible body is configured to float within a body of water.

9. The fishing lure of claim 1, wherein the support frame further comprises a plurality of knots thereon.

10. The fishing lure of claim 9, wherein the plurality of knots are disposed at regular intervals along a length of the support frame.

11. A fishing lure, comprising:
a flexible body having a first end opposite a second end;
a support frame extending through the flexible body between the first end and the second end;
wherein the support frame comprises a nylon mesh in a spiral configuration, defining a cord;
a light source disposed within the flexible body.

12. The fishing lure of claim 11, further comprising a plurality of ribs along a length of the flexible body.

13. The fishing lure of claim 12, wherein a width of the plurality of ribs decreases from the first end towards the second end.

14. The fishing lure of claim 11, further comprising a tail affixed to the second end, wherein the tail comprises a planar member.

15. The fishing lure of claim 14, wherein the tail further comprises a cutout therethrough, the cutout defining a pair of tail segments.

16. The fishing lure of claim 11, wherein the flexible body further comprises reflective flakes embedded therein.

17. The fishing lure of claim 11, wherein the light source comprises a chemiluminescent glow stick.

18. The fishing lure of claim 11, wherein the flexible body further comprises a floatation additive therein, such that the flexible body is configured to float within a body of water.

19. The fishing lure of claim 11, wherein the support frame further comprises a plurality of knots thereon.

20. The fishing lure of claim 19, wherein the plurality of knots are disposed at regular intervals along a length of the support frame.
